(19) United States
(12) Patent Application Publication
(10) Pub. No.: US 2018/0175379 A1
(43) Pub. Date: Jun. 21, 2018

(54) GERMANIUM-CONTAINING CARBON NANOTUBE ARRAYS AS ELECTRODES

(71) Applicant: William Marsh Rice University, Houston, TX (US)

(72) Inventors: James M. Tour, Bellaire, TX (US); Caitian Gao, Houston, TX (US); Nam Dong Kim, Houston, TX (US)

(73) Assignee: William Marsh Rice University, Houston, TX (US)

(21) Appl. No.: 15/735,326

(22) PCT Filed: Jun. 10, 2016
(86) PCT No.: PCT/US2016/036909

§ 371 Date: Dec. 11, 2017

Related U.S. Application Data
(60) Provisional application No. 62/173,786, filed on Jun. 10, 2015.

(51) Int. Cl. H01M 4/36; H01G 11/36; H01M 4/38; H01M 4/587; H01M 10/0525

(52) U.S. Cl. CPC H01M 4/366; H01G 11/36; H01M 10/0525; H01M 4/587; H01M 4/381

(57) ABSTRACT

Embodiments of the present disclosure pertain to electrodes that include a plurality of vertically aligned carbon nanotubes and germanium associated with the vertically aligned carbon nanotubes. The electrodes may also include a substrate (e.g., copper foil) and a carbon layer (e.g., graphene film). In some embodiments, the carbon layer may be positioned between the substrate and the vertically aligned carbon nanotubes. In some embodiments, the electrodes may be in the form of a graphene-carbon nanotube hybrid material that includes: a graphene film; and vertically aligned carbon nanotubes covalently linked to the graphene film. In some embodiments, the electrodes of the present disclosure serve as cathodes or anodes in an energy storage device. Additional embodiments pertain to energy storage devices that contain the electrodes of the present disclosure. Further embodiments of the present disclosure pertain to methods of making the electrodes and incorporating them into energy storage devices.

### CROSS-REFERENCE TO RELATED APPLICATIONS

This application claims priority to U.S. Provisional Patent Application No. 62/173,786, filed on Jun. 10, 2015. The entirety of the aforementioned application is incorporated herein by reference.

### STATEMENT REGARDING FEDERALLY SPONSORED RESEARCH

This invention was made with government support under Grant No. FA9550-14-1-0111, awarded by the U.S. Department of Defense; and Grant No. FA9550-12-1-0035, awarded by the U.S. Department of Defense. The government has certain rights in the invention.

### BACKGROUND

Current electrodes have numerous limitations, including limited electronic conductivity, limited ion diffusivity, and undesired volume expansion and pulverization during operation. The present disclosure addresses the aforementioned limitations.

### SUMMARY

In some embodiments, the present disclosure pertains to electrodes that include: a plurality of vertically aligned carbon nanotubes; and germanium associated with the vertically aligned carbon nanotubes. In some embodiments, the vertically aligned carbon nanotubes include vertically aligned single-walled carbon nanotubes that are in the form of an array.

In some embodiments, the electrodes of the present disclosure also include a substrate that serves as a current collector (e.g., a copper foil). In some embodiments, the electrodes of the present disclosure also include a carbon layer that is positioned between a substrate and the vertically aligned carbon nanotubes. In some embodiments, the carbon layer includes a graphene film. In some embodiments, the vertically aligned carbon nanotubes are covalently linked to the carbon layer.

In some embodiments, the electrodes of the present disclosure are in the form of a graphene-carbon nanotube hybrid material that includes: a graphene film; and vertically aligned carbon nanotubes covalently linked to the graphene film. In some embodiments, the vertically aligned carbon nanotubes are covalently linked to the graphene film through carbon-carbon bonds at one or more junctions between the vertically aligned carbon nanotubes and the graphene film.

In more specific embodiments, the electrodes of the present disclosure include a substrate, a graphene film associated with the substrate, vertically aligned carbon nanotubes covalently linked to the graphene film through carbon-carbon bonds at one or more junctions between the vertically aligned carbon nanotubes and the graphene film, and germanium associated with the vertically aligned carbon nanotubes. In some embodiments, the germanium is also associated with the graphene film. In some embodiments, the vertically aligned carbon nanotubes are grown seamlessly on the graphene film through the use of a catalyst that includes a metal and a buffer (e.g., a buffer layer).

Germanium may be associated with the vertically aligned carbon nanotubes of the present disclosure in various manners. For instance, in some embodiments, germanium is infiltrated between the vertically aligned carbon nanotubes. In some embodiments, germanium is deposited on surfaces of the vertically aligned carbon nanotubes. In some embodiments, germanium constitutes from about 25 wt % to about 75 wt % of the electrode.

In some embodiments, the electrodes of the present disclosure serve as components of an energy storage device (e.g., cathodes or anodes in an energy storage device). Additional embodiments of the present disclosure pertain to energy storage devices that contain the electrodes of the present disclosure. In some embodiments, the energy storage device includes, without limitation, capacitors, lithium-ion capacitors, batteries, photovoltaic devices, photovoltaic cells, transistors, current collectors, fuel cell devices, water-splitting devices, and combinations thereof. In some embodiments, the energy storage device is a battery, such as a lithium-ion battery.

Additional embodiments of the present disclosure pertain to methods of making the electrodes of the present disclosure. In some embodiments, the methods of the present disclosure include a step of applying germanium to a plurality of vertically aligned carbon nanotubes such that the germanium becomes associated with the vertically aligned carbon nanotubes. In more specific embodiments, the electrodes of the present disclosure are fabricated by associating a graphene film with a substrate; applying a catalyst (e.g., a metal and a buffer layer) and a carbon source to the graphene film; growing the vertically aligned carbon nanotubes on the graphene film to form a graphene-carbon nanotube hybrid material; and applying germanium to the plurality of vertically aligned carbon nanotubes such that the germanium becomes associated with the vertically aligned carbon nanotubes and optionally the graphene film. In some embodiments, the association of the graphene film with the substrate occurs by growing the graphene film on the substrate. In some embodiments, the methods of the present disclosure also include a step of incorporating the formed electrodes into an energy storage device.

### DESCRIPTION OF THE FIGURES

FIG. 1 illustrates the formation of electrodes (FIG. 1A), a structure of a formed electrode (FIG. 1B), and the use of the formed electrodes in a battery (FIG. 1C).

FIG. 2 provides a scheme for the synthesis of graphene-carbon nanotube hybrid materials (GCNTs) associated with germanium (Ge) (Ge/GCNT structures). FIGS. 2A-B show that few-layer graphene was grown on a copper (Cu) foil by chemical vapor deposition (CVD).

FIG. 2C shows that carbon nanotube (CNT) forests were grown directly and seamlessly from the graphene surface after iron/aluminum oxide (Fe/Al₂O₃) catalyst deposition. FIG. 2D shows that Ge was deposited on the GCNT structures by e-beam evaporation.

FIG. 3 provides scanning electron microscopy (SEM) images of graphene on copper (Cu) foil (FIG. 3A) and the corresponding Raman spectrum of graphene on Cu foil (FIG. 3B).

FIG. 4 provides SEM images of GCNT electrodes on Cu foil at different magnifications (FIGS. 4A-B) and a corresponding cross-sectional SEM image (FIG. 4C).

FIG. 5 provides data relating to the characterization of Ge/GCNTs on Cu foil (52% Ge). FIGS. 5A-B provide SEM images of Ge/GCNTs on Cu foil at different magnifications.

FIG. 5C provides a corresponding side-view SEM image. FIGS. 5D-E provide transmission electron microscopy (TEM) images of Ge/GCNTs. FIG. 5F shows a selected area electron diffraction (SAED) of Ge/GCNTs. FIG. 5G shows a scanning TEM (STEM) image of Ge/GCNTs. Also shown are the corresponding elemental mapping of Ge (FIG. 5H) and carbon (FIG. 5I) from the area defined by the red square in FIG. 5G.

FIG. 6 shows the TEM image of a Ge/GCNT structure in a triangle area (FIG. 5G) at a higher magnification.

FIG. 7 shows the spectra of a Ge/GCNT structure and its precursor. FIG. 7A shows the Raman spectroscopy of pure Ge film, GCNTs and Ge/GCNTs. The insert is the enlargement of the GCNT spectrum from 100 to 300 cm⁻¹. FIG. 7B shows the X-ray photoelectron spectroscopy (XPS) scan of Ge/GCNTs. The inset is the Ge 3d fine spectrum.

FIG. 8 shows the Raman spectrum of GCNT on Cu foil.

FIG. 9 shows the comparison of rate performance of Ge/GCNT electrodes with different Ge loadings of 39%, 52% and 61%, respectively.

FIG. 10 provides data relating to the performance of Ge/GCNT electrodes. FIG. 10A provides data relating to the rate performance of Ge/GCNT at different current densities. FIG. 10B provides the charge/discharge profiles of Ge/GCNTs at different current densities. FIG. 10C provides cyclic voltammetries (CVs) of Ge/GCNT electrodes at a scan rate of 0.4 mV/s at 0.01-1.5 V vs Li/Li⁺.

FIG. 11 provides additional data relating to the performance of Ge/GCNT electrodes. FIG. 11A provides a comparison of rate performance of Ge/GCNTs to literature values for Ge. FIG. 11B shows the electrochemical impedance spectroscopy (EIS) of Ge/GCNTs before and after rate testing. FIG. 11C shows the cycling performance of Ge/GCNT, pure Ge films and GCNT films at 0.5 A/g.

FIG. 12 shows the rate performance of pure GCNTs.

FIG. 13 shows SEM images of Ge/GCNT electrodes after 200 cycles at 0.5 A/g under small (FIG. 13A) and large (FIG. 13B) magnifications.

FIG. 14 provides additional data and schemes relating to the charge profiles of Ge/GCNTs. FIG. 14A shows the discharge and charge profiles of Ge/GCNTs. FIG. 14B shows a model for the Ge/GCNT discharge process. FIG. 14C shows a model for the Ge/GCNT charge process. FIGS. 14D-E comparatively depict the effects of charge and discharge processes on pre-existing electrodes (FIG. 14D) and Ge/GCNT electrodes (FIG. 14E).

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Lithium-ion batteries (LIB s) have dominated the energy storage field for decades due to their high energy density and long cycle life, especially in mobile device applications. With the increasing deployment of electric vehicles (EVs) and proliferation of handheld electronics that use energy storage devices (e.g., LIBs), a need exists to improve energy storage technology. The two key requirements for improved energy storage devices are higher power density and higher energy density, which determine how fast and how long, respectively, devices can be used on a single charge.

However, both anode and cathode electrode materials in many energy storage devices have limited capacity and rate capabilities. For instance, the commercial anode now used in LIBs is graphite, with a usable but low specific capacity of 372 mAh/g. As such, the development of alternative electrode materials with high reversible capacities and rate stabilities has attracted much attention.

Group IV elements, such as silicon (Si), germanium (Ge), and tin (Sn), have been considered as the most promising electrode component candidates due to their high theoretical capacities of 4200, 1600 and 994 mAh/g, respectively. Among those elements, Ge is a potential anode material for LIBs with high power density due to its higher Li ion diffusivity and higher electronic conductivity. For instance, when compared to Si-based anode materials, Ge exhibits 100,000 times higher electronic conductivity and 400 times higher lithium ion diffusivity (i.e., the ion diffusivity is 6.51×10⁻¹² cm²/s for Ge and 1.41×10⁻¹⁴ cm²/s for Si at room temperature), which can be expected to provide better rate performance and cycling stability.

Unfortunately, similar to other anode materials, Ge also presents a pulverization problem due to the large volume change of more than 300% during the discharge/charge processes. This in turn can hinder the practical applications of Ge in many energy storage devices, including LIB s.

Fabrication of composite nanostructures with other materials, such as carbon materials, carbon fibers, graphene, and carbon nanotubes, have improved the performance of Ge. For instance, it has been reported that a composite of Ge nanoparticles encapsulated in carbon has shown improved performance (Adv. Mater. 2008, 20, 3079-3083). It has also been reported that applied graphene as the matrix for Ge nanoparticles delivered a practical capacity and long cycle life (Chem. Mater. 2014, 26, 2172-2179). However, to prepare the electrode, a slurry had to be prepared by mixing an active material (AM), binder and conductive additive and then casted onto the current collector (CC). Unfortunately, this process introduced a high contact resistance between the AM and CC. Moreover, in some instances, the AM may peel away from the CC due to pulverization.

To solve the aforementioned problems, researchers have attempted to directly construct hierarchical structures on CC, such as carbon nanotubes, and cobalt oxide, thereby forming an additive-free electrode. Those ordered arrays have been used as secondary nanoporous electrodes with high specific surface areas (SSA). The ordered arrays have also served as effective transport for electrons and lithium ions.

However, another problem arose from the aforementioned structure. In particular, the hierarchical electrodes may also peel off the CC due to the large strain which results from the difference of volume expansion between the electrodes and CCs. The volume expansion occurs only in the electrodes, while CCs themselves are inactive to lithium. Correspondingly, a large strain arises at the interfaces. This can greatly hinder the electrochemical performances. To date, little attention has been focused on solving this issue.

As such, a need exists for electrodes that have improved electronic conductivity and ion diffusivity while displaying minimal volume expansion and pulverization during operation. Various embodiments of the present disclosure address the aforementioned need.

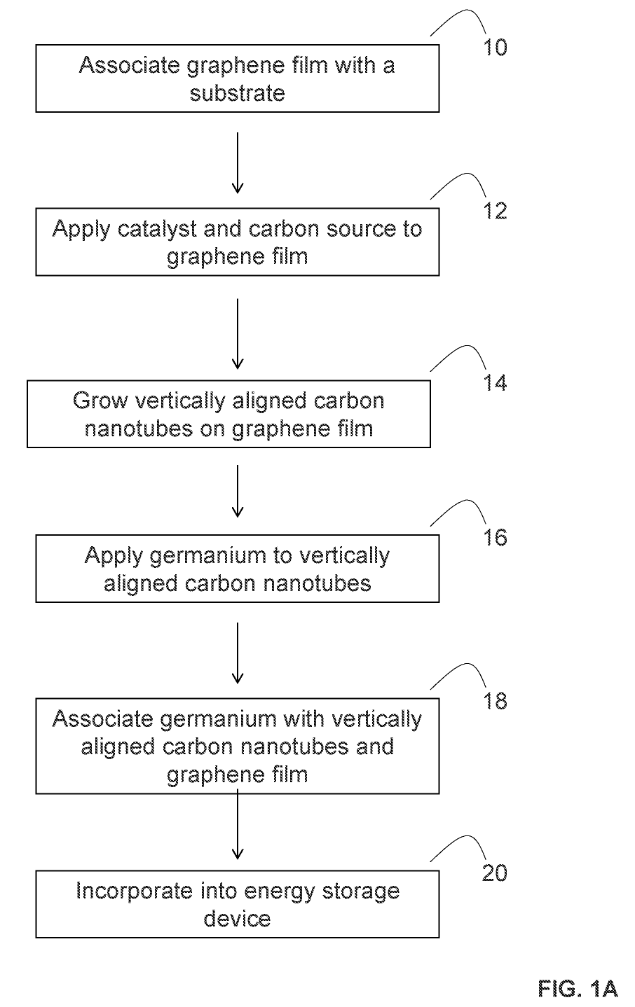

In some embodiments, the present disclosure pertains to methods of forming electrodes. In some embodiments, the methods of the present disclosure include applying germanium to a plurality of vertically aligned carbon nanotubes such that the germanium becomes associated with the vertically aligned carbon nanotubes. In more specific embodiments illustrated in FIG. 1A, the methods of the present disclosure include associating a graphene film with a substrate (step 10); applying a catalyst (e.g., a metal and a buffer layer) and a carbon source to the graphene film (step 12); growing the vertically aligned carbon nanotubes on the graphene film to form a graphene-carbon nanotube hybrid material (step 14); and applying germanium to the plurality of vertically aligned carbon nanotubes (step 16) such that the germanium becomes associated with the vertically aligned carbon nanotubes and optionally the graphene film (step 18). In some embodiments, the methods of the present disclosure also include a step of incorporating the formed electrode as a component of an energy storage device (step 20).

In additional embodiments, the present disclosure pertains to the formed electrodes. In some embodiments, the electrodes of the present disclosure include a plurality of vertically aligned carbon nanotubes and germanium associated with the vertically aligned carbon nanotubes. In some embodiments, the electrodes of the present disclosure also include a substrate and a carbon layer.

In more specific embodiments illustrated in FIG. 1B, the electrodes of the present disclosure can be in the form of electrode 30, which includes germanium 32, vertically aligned carbon nanotubes 34, graphene film 38, and substrate 40. In this embodiment, vertically aligned carbon nanotubes 34 are in the form of an array 35. Moreover, the vertically aligned carbon nanotubes are covalently linked to graphene film 38 through seamless junctions 36. In addition, germanium 32 is associated with vertically aligned carbon nanotubes 34 by infiltration between the vertically aligned carbon nanotubes and deposition on surfaces of the vertically aligned carbon nanotubes. Germanium 32 may also be associated with graphene film 38.

Further embodiments of the present disclosure pertain to energy storage devices that contain the electrodes of the present disclosure. For instance, as illustrated in FIG. 1C, the electrodes of the present disclosure can be utilized as components of battery 50, which contains cathode 52, anode 56, and electrolytes 54. In this embodiment, the electrodes of the present disclosure can serve as cathode 52 or anode 56.

As set forth in more detail herein, the methods and electrodes of the present disclosure can utilize various types of vertically aligned carbon nanotubes. Moreover, various amounts of germanium may be associated with the vertically aligned carbon nanotubes in various manners. Furthermore, the electrodes of the present disclosure can be utilized as components of various energy storage devices.

Vertically Aligned Carbon Nanotubes

The electrodes of the present disclosure can include various types of vertically aligned carbon nanotubes. For instance, in some embodiments, the vertically aligned carbon nanotubes include, without limitation, single-walled carbon nanotubes, double-walled carbon nanotubes, triple-walled carbon nanotubes, multi-walled carbon nanotubes, ultra-short carbon nanotubes, small diameter carbon nanotubes, pristine carbon nanotubes, functionalized carbon nanotubes, and combinations thereof. In some embodiments, the vertically aligned carbon nanotubes include vertically aligned single-walled carbon nanotubes.

In some embodiments, the vertically aligned carbon nanotubes of the present disclosure include pristine carbon nanotubes. In some embodiments, the pristine carbon nanotubes have little or no defects or impurities.

In some embodiments, the vertically aligned carbon nanotubes of the present disclosure include functionalized carbon nanotubes. In some embodiments, the functionalized carbon nanotubes include sidewall-functionalized carbon nanotubes. In some embodiments, the functionalized carbon nanotubes include one or more functionalizing agents. In some embodiments, the functionalizing agents include, without limitation, oxygen groups, hydroxyl groups, carboxyl groups, epoxide moieties, and combinations thereof.

In some embodiments, the sidewalls of the vertically aligned carbon nanotubes of the present disclosure contain structural defects, such as holes. In some embodiments, carbons at the edges of the structural defects (e.g., holes) are terminated by one or more atoms or functional groups (e.g., hydrogen, oxygen groups, hydroxyl groups, carboxyl, groups, epoxide moieties, and combinations thereof).

The vertically aligned carbon nanotubes of the present disclosure can be in various forms. For instance, in some embodiments, the vertically aligned carbon nanotubes are in the form of at least one of carbon nanotube arrays, carbon nanotube forests, carbon nanotube bundles, and combinations thereof. In some embodiments, the vertically aligned carbon nanotubes are in the form of carbon nanotube bundles. In some embodiments, the vertically aligned carbon nanotubes are in the form of an array (e.g., array 35 in FIG. 1B). In some embodiments, the array is in the form of a carpet or a forest. In some embodiments, the array is in the form of superlattices held together by van der Waals interactions.

In some embodiments, the vertically aligned carbon nanotubes of the present disclosure are in the form of carbon nanotube bundles that include a plurality of channels. In some embodiments, the carbon nanotube bundles have inter-tube spacings ranging from about 3 Å to about 20 Å. In some embodiments, the carbon nanotube bundles have inter-tube spacings of about 3.4 Å. In some embodiments, the carbon nanotube bundles have channels with sizes that range from about 5 Å to about 20 Å. In some embodiments, the carbon nanotube bundles have channels with sizes of about 6 Å.

The vertically aligned carbon nanotubes of the present disclosure can have various angles relative to a base layer (e.g., a substrate, such as a metal substrate; or a carbon layer, such as a graphene film). For instance, in some embodiments, the vertically aligned carbon nanotubes of the present disclosure have angles that range from about 45° to about 90°. In some embodiments, the vertically aligned carbon nanotubes of the present disclosure have angles that range from about 75° to about 90°. In some embodiments, the vertically aligned carbon nanotubes of the present disclosure have an angle of about 90°.

The vertically aligned carbon nanotubes of the present disclosure can also have various thicknesses. For instance, in some embodiments, the vertically aligned carbon nanotubes of the present disclosure have a thickness ranging from about 10 μm to about 2 mm. In some embodiments, the vertically aligned carbon nanotubes of the present disclosure have a thickness ranging from about 10 μm to about 500 μm. In some embodiments, the vertically aligned carbon nanotubes of the present disclosure have a thickness ranging from about 10 μm to about 100 μm. In some embodiments, the vertically aligned carbon nanotubes of the present disclosure have a thickness of about 50 μm. In some embodiments, the vertically aligned carbon nanotubes of the present disclosure have a thickness of about 10 μm.

Substrates

In some embodiments, the electrodes of the present disclosure may also include a substrate (e.g., substrate 40 in FIG. 1B). In some embodiments, the substrate serves as a current collector. In some embodiments, the substrate and the vertically aligned carbon nanotubes serve as a current collector.

Various substrates may be utilized in the electrodes of the present disclosure. In some embodiments, the substrate includes a metal substrate. In some embodiments, the substrate includes a porous substrate. In some embodiments, the substrate includes, without limitation, nickel, cobalt, iron, platinum, gold, aluminum, chromium, copper, magnesium, manganese, molybdenum, rhodium, ruthenium, silicon, silicon carbide, tantalum, titanium, tungsten, uranium, vanadium, zirconium, silicon dioxide, aluminum oxide, boron nitride, carbon, carbon-based substrates, diamond, graphite, graphoil, steel, alloys thereof, foils thereof, foams thereof, and combinations thereof. In some embodiments, the substrate includes a copper substrate, such as a copper foil.

In some embodiments, the substrate includes a porous substrate. In some embodiments, the porous substrate has a plurality of micropores, nanopores, mesopores, and combinations thereof.

The vertically aligned carbon nanotubes of the present disclosure may be associated with a substrate in various manners. For instance, in some embodiments, the vertically aligned carbon nanotubes of the present disclosure are associated with a surface of a substrate. In some embodiments, the vertically aligned carbon nanotubes of the present disclosure are non-covalently linked to the substrate through various interactions, such as ionic interactions, acid-base interactions, hydrogen bonding interactions, pi-stacking interactions, van der Waals interactions, adsorption, physisorption, self-assembly, stacking, packing, sequestration, and combinations thereof. In some embodiments, the vertically aligned carbon nanotubes of the present disclosure are substantially perpendicular to the substrate.

In some embodiments, the vertically aligned carbon nanotubes of the present disclosure are directly associated with a substrate. In some embodiments, the vertically aligned carbon nanotubes of the present disclosure are indirectly associated with a substrate.

Carbon Layers

In some embodiments, the electrodes of the present disclosure may also include a carbon layer. The carbon layer may have various arrangements in the electrodes of the present disclosure. For instance, in some embodiments, the carbon layer is positioned between a substrate and the vertically aligned carbon nanotubes. In some embodiments, the vertically aligned carbon nanotubes are directly associated with a carbon layer. In some embodiments, the vertically aligned carbon nanotubes are covalently linked to a carbon layer.

In some embodiments, the vertically aligned carbon nanotubes are covalently linked to a carbon layer while the carbon layer is associated with a substrate. In some embodiments, the carbon layer is covalently linked to a substrate. In some embodiments, the carbon layer is non-covalently linked to a substrate through various interactions that were described previously, such as van der Waals interactions.

The electrodes of the present disclosure can include various carbon layers. For instance, in some embodiments, the carbon layer includes, without limitation, graphitic substrates, graphene, graphite, buckypapers, carbon fibers, carbon fiber papers, carbon papers, graphene papers, carbon films, graphene films, graphoil, and combinations thereof.

In some embodiments, the carbon layer includes a graphene film (e.g., graphene film 38 in FIG. 1B). In some embodiments, the graphene film includes, without limitation, monolayer graphene, double-layer graphene, triple-layer graphene, few-layer graphene, multi-layer graphene, graphene nanoribbons, graphene oxide, reduced graphene oxide, graphite, and combinations thereof. In some embodiments, the graphene film includes reduced graphene oxide. In some embodiments, the graphene film includes graphite.

Graphene-Carbon Nanotube Hybrid Materials

In some embodiments, the electrodes of the present disclosure include graphene-carbon nanotube hybrid materials. In some embodiments, the graphene-carbon nanotube hybrid materials include a graphene film (e.g., graphene film 38 in FIG. 1B) and vertically aligned carbon nanotubes covalently linked to the graphene film (e.g., vertically aligned carbon nanotubes 34 in FIG. 1B). In some embodiments, the vertically aligned carbon nanotubes are covalently linked to the graphene film through carbon-carbon bonds at one or more junctions between the carbon nanotubes and the graphene film (e.g., junction 36 in FIG. 1B). In some embodiments, the vertically aligned carbon nanotubes are in ohmic contact with a graphene film through the carbon-carbon bonds at the one or more junctions. In some embodiments, the one or more junctions include seven-membered carbon rings. In some embodiments, the one or more junctions are seamless. In some embodiments, the graphene-carbon nanotube hybrid materials of the present disclosure can also include a substrate that is associated with the graphene film (e.g., substrate 40 in FIG. 1B). Suitable substrates were described previously. For instance, in some embodiments, the substrate can include a metal substrate, such as copper. In some embodiments, the substrate includes a carbon-based substrate, such as a graphitic substrate. In some embodiments, the carbon-based substrate can work both as a current collector and a carbon source for the growth of carbon nanotubes.

The graphene-carbon nanotube hybrid materials of the present disclosure can include various graphene films. Suitable graphene films were described previously. For instance, in some embodiments, the graphene film can include monolayer graphene.

The vertically aligned carbon nanotubes of the present disclosure may be associated with graphene films in various manners. For instance, in some embodiments, the vertically aligned carbon nanotubes are substantially perpendicular to the graphene film (e.g., vertically aligned carbon nanotubes 34 in FIG. 1B). In some embodiments, the vertically aligned carbon nanotubes of the present disclosure are associated with graphene films at angles that range from about 45° to about 90° relative to the graphene film, while the graphene film remains parallel with the substrate (e.g., a metal upon which graphene films are grown).

In more specific embodiments, the electrodes of the present disclosure include a substrate (e.g., a metal substrate); a graphene film associated with the substrate; vertically aligned carbon nanotubes covalently linked to the graphene film through carbon-carbon bonds at one or more junctions between the vertically aligned carbon nanotubes and the graphene film; and germanium associated with the vertically aligned carbon nanotubes. In some embodiments, the germanium is also associated with the graphene film. In some embodiments, the graphene film is grown on the substrate. In some embodiments, the vertically aligned carbon nanotubes are grown seamlessly on the graphene film through the use of a catalyst that includes a metal and a buffer (e.g., a buffer layer).

The graphene-carbon nanotube hybrid materials of the present disclosure can be prepared by various methods. For instance, in some embodiments, the graphene-carbon nanotube hybrid materials of the present disclosure can be made by: (1) associating a graphene film with a substrate; (2) applying a catalyst and a carbon source to the graphene film; and (3) growing vertically aligned carbon nanotubes on the graphene film to form a graphene-carbon nanotube hybrid material; and (4) applying germanium to the vertically aligned carbon nanotubes, such that the germanium becomes associated with the vertically aligned carbon nanotubes. In some embodiments, the germanium also becomes associated with the graphene film.

In some embodiments, the vertically aligned carbon nanotubes are grown seamlessly on the graphene film. In some embodiments, the vertically aligned carbon nanotubes are covalently linked to the graphene film through carbon-carbon bonds at one or more junctions between the vertically aligned carbon nanotubes and the graphene film.

In some embodiments, a graphene film becomes associated with a substrate by transferring a pre-grown graphene film onto the substrate (See, e.g., Nano Lett., 2016, 16 (2), pp 1287-1292). In some embodiments, a graphene film becomes associated with a substrate by growing a graphene film on the substrate (See, e.g., Nature Communications, 3:1225, November 2012; ACS Nano, 2013, 7 (1), pp 58-64; and Nano Lett., 2013, 13 (1), pp 72-78). In some embodiments, graphene films are grown on the substrate by chemical vapor deposition. In some embodiments, graphene films can be grown on the substrate from various carbon sources, such as gaseous or solid carbon sources.

Various catalysts may be applied to a graphene film to grow vertically aligned carbon nanotubes. For instance, in some embodiments, catalysts may include a metal (e.g., iron) and a buffer (e.g., an alumina, such as an alumina layer). In some embodiments, the metal (e.g., iron) and buffer (e.g., alumina layer) can be grown from nanoparticles (e.g., iron alumina nanoparticles). In some embodiments, the metals can include, without limitation, metal oxides, metal chalcogenides, iron nanoparticles (e.g., Fe₃O₄), and combinations thereof.

In some embodiments, the buffer includes aluminum oxides (e.g., Al₂O₃). In some embodiments, the buffer is in the form of a layer. In some embodiments, the metal and buffer are sequentially deposited onto a graphene film by various methods, such as electron beam deposition or wet-chemical deposition from water or organic solvents.

Carbon sources may be applied to a graphene film by various methods in order to grow vertically aligned carbon nanotubes. For instance, in some embodiments, carbon sources (e.g., ethene or ethyne) may be deposited onto the graphene film by various methods, such as chemical vapor deposition. In some embodiments, the graphene film can be grown on a substrate from various carbon sources, such as gaseous or solid carbon sources.

Additional embodiments of graphene-carbon nanotube hybrid materials and methods of making the hybrid materials are described in an additional PCT application by Applicants, which has been published as WO 2013/119,295. Additional embodiments of methods of growing graphene films are disclosed in Applicants' U.S. Pat. No. 9,096,437, U.S. Pat. Pub. No. 2014/0014030, and U.S. Pat. Pub. No. 2014/0178688. Additional catalysts for growing vertically aligned carbon nanotubes are disclosed in U.S. Provisional Pat. App. No. 62/276,126. The entirety of each of the aforementioned applications is incorporated herein by reference.

Application of Germanium to Vertically Aligned Carbon Nanotubes

Various methods may be utilized to apply germanium to vertically aligned carbon nanotubes. For instance, in some embodiments, the applying occurs by filtration, ultrafiltration, coating, spin coating, spraying, spray coating, patterning, mixing, blending, loading, ball-milling methods, thermal activation, electro-deposition, electrochemical deposition, electron beam evaporation, cyclic voltammetry, doctor-blade coating, screen printing, gravure printing, direct write printing, inkjet printing, mechanical pressing, melting, melt diffusion, wet chemistry methods, solution-based methods, freeze-drying methods, hydrothermal-based methods, sputtering, atomic-layer deposition, and combinations thereof. In some embodiments, the applying occurs by electrochemical deposition. In some embodiments, the applying occurs by electron beam evaporation. The application of germanium to vertically aligned carbon nanotubes can occur at various times. For instance, in some embodiments, the applying occurs during electrode fabrication. In some embodiments, the applying occurs after electrode fabrication.

In some embodiments, the germanium is in the form of a salt during the applying step. In some embodiment, the germanium may be in the form of Ge (IV) species (e.g., H₂GeO₃ and GeCl₄) during the applying step.

In some embodiments, the applying occurs by melting germanium over a surface of vertically aligned carbon nanotubes. Thereafter, the germanium can become associated with the vertically aligned carbon nanotubes during the wetting of the vertically aligned carbon nanotubes by the liquid germanium.

In some embodiments, the applying occurs by electro-depositing germanium over a surface of vertically aligned carbon nanotubes. Thereafter, the germanium can become associated with the vertically aligned carbon nanotubes during the electro-deposition. In some embodiments, the germanium salts may be dissolved in an aqueous or organic electrolyte during electro-deposition.

In more specific embodiments, electro-deposition of germanium occurs by applying Ge (IV) species (e.g., H₂GeO₃ and GeCl₄) in aqueous or organic solutions onto vertically aligned carbon nanotubes. In some embodiments, the applying occurs by cyclic voltammetry. Various cyclic voltammetry processes may be utilized (See, e.g., Langmuir, 2010, 26 (4), pp 2877-2884; and J Solid State Electronchem (2015) 19; 785-793).

Association of Germanium with Vertically Aligned Carbon Nanotubes

Germanium can become associated with vertically aligned carbon nanotubes in various manners. For instance, in some embodiments, the germanium becomes infiltrated between the vertically aligned carbon nanotubes. In some embodiments, germanium becomes infiltrated between the bundles of vertically aligned carbon nanotubes.

In some embodiments, germanium is deposited on surfaces of the vertically aligned carbon nanotubes. In some embodiments, germanium forms a coating on the surfaces of the vertically aligned carbon nanotubes. In some embodiments, germanium becomes associated with the vertically aligned carbon nanotubes in the form of a film. In some embodiments, the film is on the surface of the vertically aligned carbon nanotubes.

In some embodiments, the germanium is infiltrated between the vertically aligned carbon nanotubes and deposited on surfaces of the vertically aligned carbon nanotubes. In some embodiments, germanium can become associated with vertically aligned carbon nanotubes in a uniform manner. In some embodiments, germanium becomes associated with the vertically aligned carbon nanotubes without forming aggregates. In some embodiments, germanium becomes associated with the vertically aligned carbon nanotubes and forms aggregates.

In some embodiments, the germanium becomes associated with vertically aligned carbon nanotubes by forming at least one of germanium-carbon bonds, van der Waals interactions, and combinations thereof. Additional modes of associations can also be envisioned.

The electrodes of the present disclosure may include various amounts of germanium. For instance, in some embodiments, the germanium constitutes from about 25 wt % to about 75 wt % of the electrode (e.g., mass of germanium divided by the whole mass of germanium and the vertically aligned carbon nanotube structure). In some embodiments, the germanium constitutes from about 35 wt % to about 65 wt % of the electrode. In some embodiments, the germanium constitutes more than about 50 wt % of the electrode. In some embodiments, the germanium constitutes from about 50 wt % to about 65 wt % of the electrode. In some embodiments, the germanium constitutes from about 39 wt % to about 61 wt % of the electrode. In some embodiments, the germanium constitutes from about 52 wt % to about 61 wt % of the electrode.

Electrode Structures and Properties

The electrodes of the present disclosure can have various structures. For instance, in some embodiments, the electrodes of the present disclosure are in the form of films, sheets, papers, mats, scrolls, conformal coatings, foams, sponges, and combinations thereof. In some embodiments, the electrodes of the present disclosure have a three-dimensional structure (e.g., foams and sponges). In some embodiments, the electrodes of the present disclosure have a two-dimensional structure (e.g., films, sheets and papers). In some embodiments, the electrodes of the present disclosure are in the form of flexible electrodes.

The electrodes of the present disclosure can serve various functions. For instance, in some embodiments, the electrodes of the present disclosure can serve as an anode. In some embodiments, the electrodes of the present disclosure can serve as a cathode. In some embodiments, the electrodes of the present disclosure can be used as binder-free and additive-free electrodes, such as anodes.

Different components of the electrodes of the present disclosure can serve various functions. For instance, in some embodiments, the vertically aligned carbon nanotubes serve as the active layer of the electrodes (e.g., active layers of cathodes and anodes). In other embodiments, the germanium serves as the electrode active layer while vertically aligned carbon nanotubes serve as a current collector. In some embodiments, vertically aligned carbon nanotubes serve as a current collector in conjunction with a substrate (e.g., a copper substrate associated with a graphene film).

The electrodes of the present disclosure can have various advantageous properties. For instance, in some embodiments, the electrodes of the present disclosure have surface areas that are more than about 650 m²/g. In some embodiments, the electrodes of the present disclosure have surface areas that are more than about 2,000 m²/g. In some embodiments, the electrodes of the present disclosure have surface areas that range from about 2,000 m²/g to about 3,000 m²/g. In some embodiments, the electrodes of the present disclosure have surface areas that range from about 2,000 m²/g to about 2,600 m²/g. In some embodiments, the electrodes of the present disclosure have a surface area of about 2,600 m²/g.

In some embodiments, a carbon layer (e.g., graphene film) that is in conformal contact with a substrate (e.g., a metal substrate) can prevent the formation of oxides between the vertically aligned carbon nanotubes and substrates. This in turn can prevent the formation of diodes at a base point, thereby enhancing conductivity between the vertically aligned carbon nanotubes and a substrate.

The electrodes of the present disclosure can also have high specific capacities. For instance, in some embodiments, the electrodes of the present disclosure have specific capacities of more than about 400 mAh/g. In some embodiments, the electrodes of the present disclosure have specific capacities of more than about 800 mAh/g. In some embodiments, the electrodes of the present disclosure have specific capacities of more than about 1,500 mAh/g. In some embodiments, the electrodes of the present disclosure have specific capacities ranging from about 800 mAh/g to about 1,600 mAh/g.

In some embodiments, the electrodes of the present disclosure retain at least 90% of their specific capacity after more than about 100 cycles. In some embodiments, the electrodes of the present disclosure retain at least 90% of their specific capacity after more than about 200 cycles. In some embodiments, the electrodes of the present disclosure retain at least 90% of their specific capacity after more than about 500 cycles. In some embodiments, the electrodes of the present disclosure retain at least 90% of their specific capacity after more than about 1,000 cycles.

Incorporation into Energy Storage Devices

The methods of the present disclosure can also include a step of incorporating the electrodes of the present disclosure as a component of an energy storage device. Additional embodiments of the present disclosure pertain to energy storage devices that contain the electrodes of the present disclosure.

The electrodes of the present disclosure can be utilized as components of various energy storage devices. For instance, in some embodiments, the energy storage device includes, without limitation, capacitors, lithium-ion capacitors, batteries, photovoltaic devices, photovoltaic cells, transistors, current collectors, fuel cell devices, water-splitting devices, and combinations thereof.

In some embodiments, the energy storage device is a capacitor. In some embodiments, the capacitor includes, without limitation, lithium-ion capacitors, super capacitors, micro supercapacitors, pseudo capacitors, two-electrode electric double-layer capacitors (EDLC), and combinations thereof.

In some embodiments, the energy storage device is a battery (e.g., battery 50 in FIG. 1C). In some embodiments, the battery includes, without limitation, rechargeable batteries, non-rechargeable batteries, micro batteries, lithium-ion batteries, lithium-sulfur batteries, lithium-air batteries, sodium-ion batteries, sodium-sulfur batteries, sodium-air batteries, magnesium-ion batteries, magnesium-sulfur batteries, magnesium-air batteries, aluminum-ion batteries, aluminum-sulfur batteries, aluminum-air batteries, calcium-ion batteries, calcium-sulfur batteries, calcium-air batteries, zinc-ion batteries, zinc-sulfur batteries, zinc-air batteries, and combinations thereof. In some embodiments, the energy storage device is a lithium-ion battery.

In some embodiments, the energy storage device is a lithium-sulfur battery. In some embodiments, the energy storage device is a capacitor. In some embodiments, the capacitor is a lithium-ion capacitor.

The electrodes of the present disclosure can be utilized as various components of energy storage devices. For instance, in some embodiments, the electrodes of the present disclosure are utilized as a cathode in an energy storage device (e.g., cathode 52 in battery 50, as illustrated in FIG. 1C). In some embodiments, the electrodes of the present disclosure are utilized as anodes in an energy storage device (e.g., anode 56 in battery 50, as illustrated in FIG. 1C).

In some embodiments, the electrodes of the present disclosure include a graphene-carbon nanotube hybrid material that is utilized as an anode in an energy storage device. In some embodiments, the anodes of the present disclosure may be associated with various cathodes. For instance, in some embodiments, the cathode is a transition metal compound. In some embodiments, the transition metal compound includes, without limitation, LiₓCoO₂, LiₓFePO₄, LiₓNiO₂, LiₓMnO₂, LiₐNi_{b}Mn_{c}Co_{d}O₂, LiₐNi_{b}Co_{c}Al_{d}O₂, NiO, NiOOH, and combinations thereof. In some embodiments, integers a,b,c,d, and x are more than 0 and less than 1.

In some embodiments, cathodes that are utilized along with the anodes of the present disclosure include sulfur. In some embodiments, the cathode includes oxygen, such as dioxygen, peroxide, superoxide, and combinations thereof. In some embodiments, the cathode contains metal oxides, such as metal peroxides, metal superoxides, metal hydroxides, and combinations thereof. In some embodiments, the cathode includes lithium cobalt oxide. In some embodiments, the cathode includes a sulfur/carbon black cathode.

In some embodiments, the energy storage devices that contain the electrodes of the present disclosure may also contain electrolytes (e.g., electrolytes 54 in battery 50, as illustrated in FIG. 1C). In some embodiments, the electrolytes include, without limitation, non-aqueous solutions, aqueous solutions, salts, solvents, ionic liquids, additives, composite materials, and combinations thereof. In some embodiments, the electrolytes include, without limitation, lithium hexafluorophosphate (LiPF6), lithium (trimethylfluorosulfonyl) imide (LITFSI), lithium (fluorosulfonyl) imide (LIFSI), lithium bis(oxalate)borate (LiBOB), hexamethylphosphoustriamide (HMPA), and combinations thereof. In some embodiments, the electrolytes are in the form of a composite material. In some embodiments, the electrolytes include solvents, such as ethylene carbonate, diethyl carbonate, dimethyl carbonate, ethyl methyl carbonate, 1,2-dimethoxyl methane, and combinations thereof.

The electrodes of the present disclosure can provide various advantageous properties in energy storage devices. For instance, in some embodiments, carbon layers (e.g., graphene films) in electrodes serve as a linking agent between the vertically aligned carbon nanotubes and a substrate (e.g., copper), thereby providing highly conductive electron transfer pathways during charge and discharge processes. In some embodiments, carbon layers (e.g. graphene films) can alleviate the strain between the electrode and the substrate (e.g., copper) during the charge and discharge processes.

In addition, due to their large surface areas (e.g., more than 2,000 m²/g), the electrodes of the present disclosure can accommodate large amounts of germanium (e.g., more than 50 wt %). The germanium can in turn enhance ion (e.g., lithium) diffusivity within the energy storage device. Moreover, the compact structure of the electrodes can provide fast ion (e.g., lithium) transport within the energy storage devices while minimizing volume expansion and pulverization.

### Additional Embodiments

Reference will now be made to more specific embodiments of the present disclosure and experimental results that provide support for such embodiments. However, Applicants note that the disclosure below is for illustrative purposes only and is not intended to limit the scope of the claimed subject matter in any way.

### Example 1. Germanium on Seamless Graphene Carbon Nanotube Hybrid Materials

In this Example, a graphene and carbon nanotube (GCNT) hybrid structure was fabricated on a copper (Cu) foil substrate. The graphene serves as a carbon layer that has good connections both with the copper foil and the carbon nanotubes (CNTs), but also minimizes the strain that occurs at the interface between the copper foil substrate and the carbon nanotubes. In the GCNT hybrid structure, the CNT array serves as a secondary nanoporous electrode while the copper foil serves as a current collector (CC).

Germanium (Ge) was deposited on the GCNTs to form a Ge/GCNT structure. The entire Ge/GCNT structure acts as an optimal electrode for lithium ion batteries (LIBs) without any binder or conductive additive. The Ge/GCNT anode delivered optimal electrochemical properties, especially rate capability. The cells can be charged at 40 A/g (25 C) with a large specific capacity of 803 mAh/g.

To produce this device, high-quality conductive graphene was grown on a Cu metal substrate, providing optimal contact with the CC, using the chemical vapor deposition (CVD) method. This was followed by the few-walled CNT carpet growth on the graphene. The Ge film was uniformly deposited on this structure, forming a binder and conductive additive-free anode for LIB s.

The formed Ge/GCNTs anode delivers long-term stability and optimal rate capability. The specific capacity is higher than 800 mAh/g, even under an extreme current density of 40 A/g. To the best of Applicants' knowledge, the Ge/GCNTs deliver the best rate when compared to other reported Ge-based anode materials. Without being bound by theory, it is envisioned that this optimal performance is attributed to the high quality contacts between CC, graphene and CNTs, high electrical conductivity, large specific surface area (SSA) and good mechanical properties of GCNTs. Moreover, it is envisioned that the aforementioned structure is a promising electrode material for other active materials that undergo large volume changes during the lithiation/delithiation in LIBs and even for other applications, such as lithium sulfur batteries.

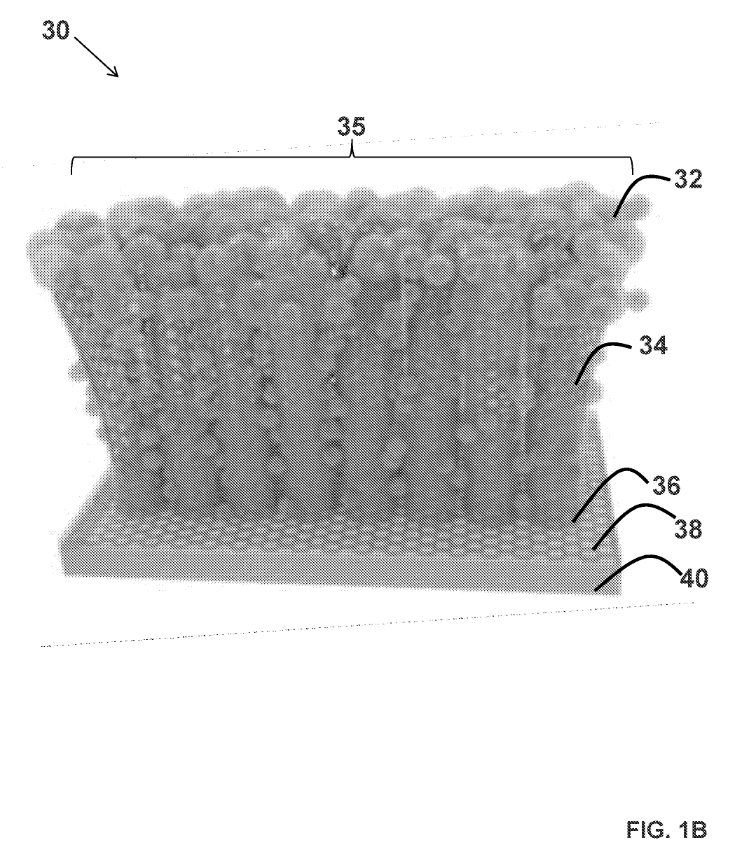

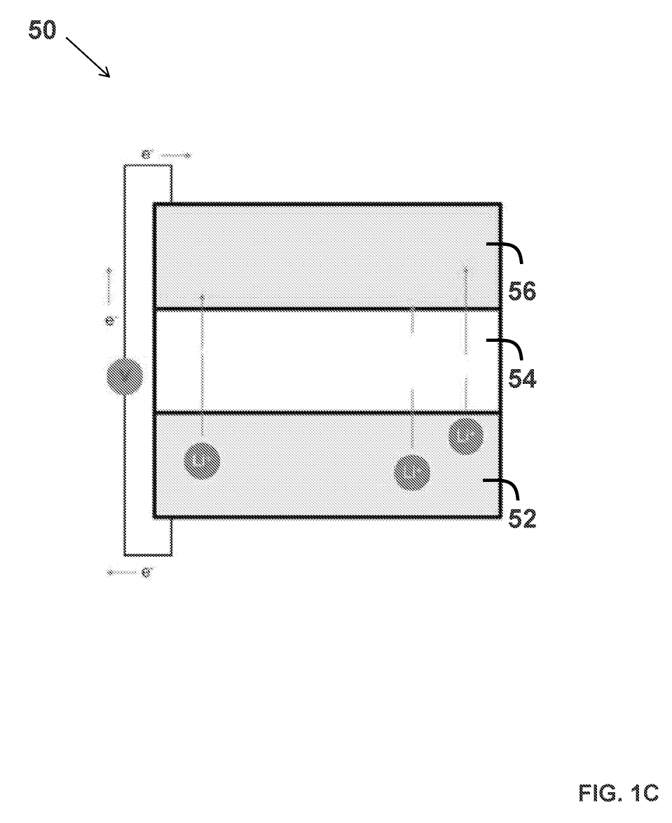

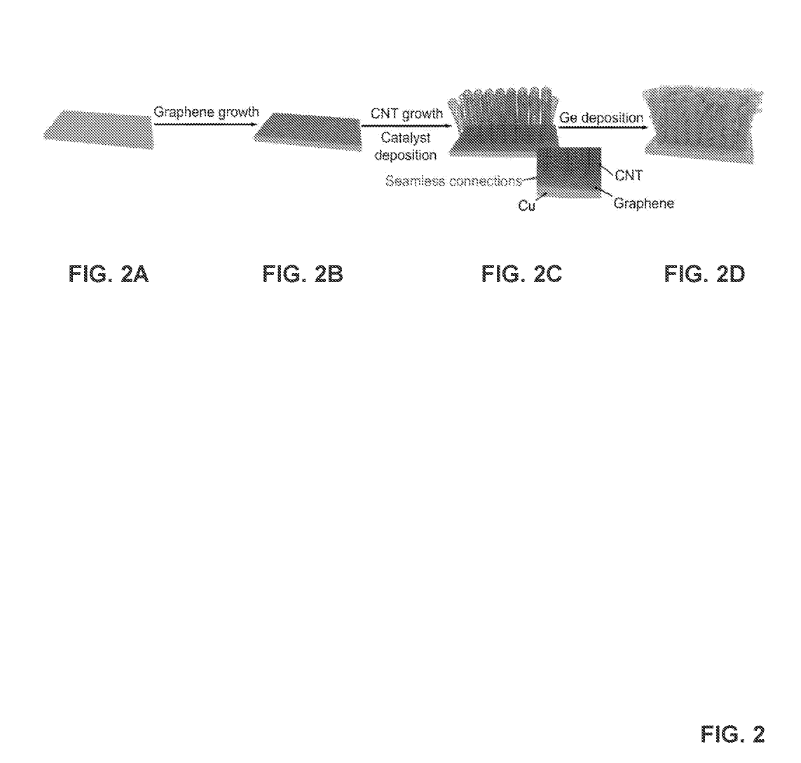

A schematic of the synthesis of Ge/GCNTs nanocomposites is shown in FIG. 2. Few-layer graphene was grown on an electrochemically polished copper foil substrate (FIGS. 2A-B) by pressure controlled chemical vapor deposition (CVD). The scanning electron microscopy (SEM) image and Raman spectrum of graphene is shown in FIG. 3, indicating that the few-layer graphene grew homogeneously on the large scale on Cu.

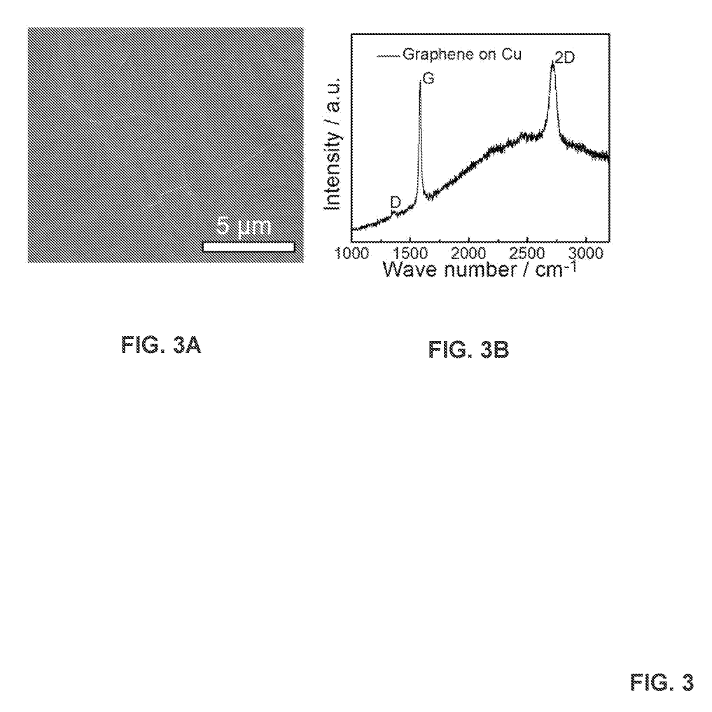

The CNT catalyst layer, 1 nm Fe, and 1 nm Al₂O₃, were directly deposited on top of the graphene by e-beam evaporation. The CNT forest was grown on top of the few-layer graphene, presumably through the Odako growth mechanism, resulting in the formation of GCNTs. The thickness of the catalyst and conditions for CNT forest growth were carefully selected to produce a bundled GCNT morphology, rather than a box-shaped carpet (FIG. 4A), so as to facilitate effective Ge deposition (FIG. 4). As reported, this growth strategy produces two well-connected interfaces: (1) a strong van der Waals interface between copper and graphene, and (2) a seamless covalent interface between graphene and CNTs.

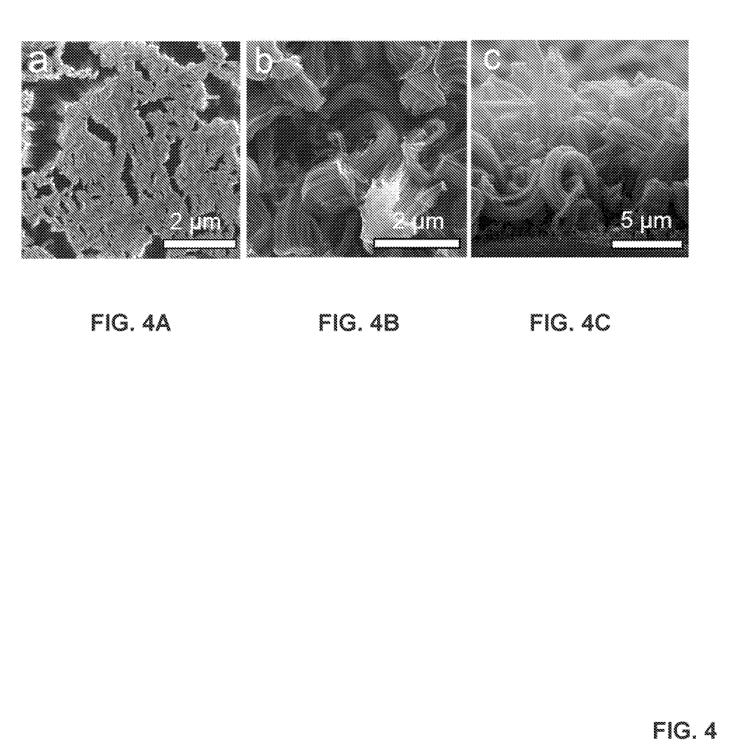

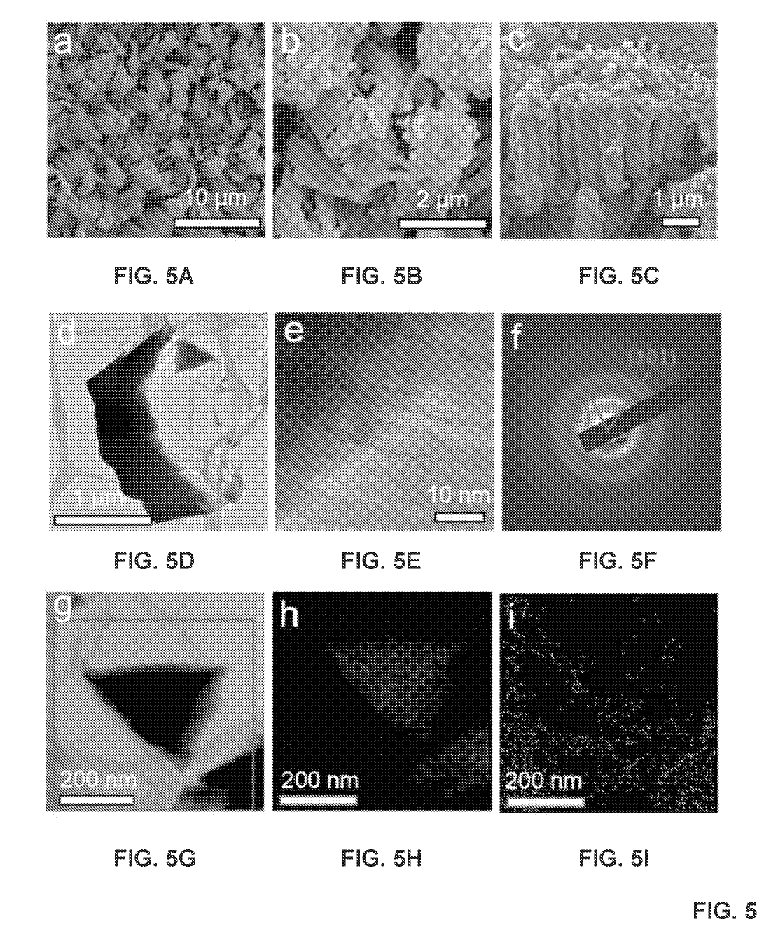

Ge was directly deposited by e-beam evaporation on the three-dimensional GCNT to form a Ge/GCNT structure (FIG. 2D). FIG. 5 shows scanning electron microscope (SEM), transmission electron microscope (TEM) and scanning tunneling electron microscope (STEM) images of the Ge/GCNT electrode. Low magnification SEM images show the deposition of Ge on GCNT is uniform and homogeneous (FIG. 5A). Comparing the high magnification SEM images of Ge/GCNT (FIGS. 5B-C) with that of bare GCNTs (FIG. 4), it appears that Ge is deposited not only on the surface, but also in some of the interior space of the GCNTs. The bundle-like GCNT forest height of 10 μm can be seen in the cross-sectional SEM image (FIG. 4C). TEM images in low and high magnification (FIGS. 5D-E) show the Ge covering the CNTs bundles, which is consistent with the SEM images. The selected area electron diffraction (SAED, FIG. 5F) shows that the CNTs have high crystallinity with (002) and (101) lattice planes, whereas the broad rings are attributed to Ge, indicating its amorphous structure.

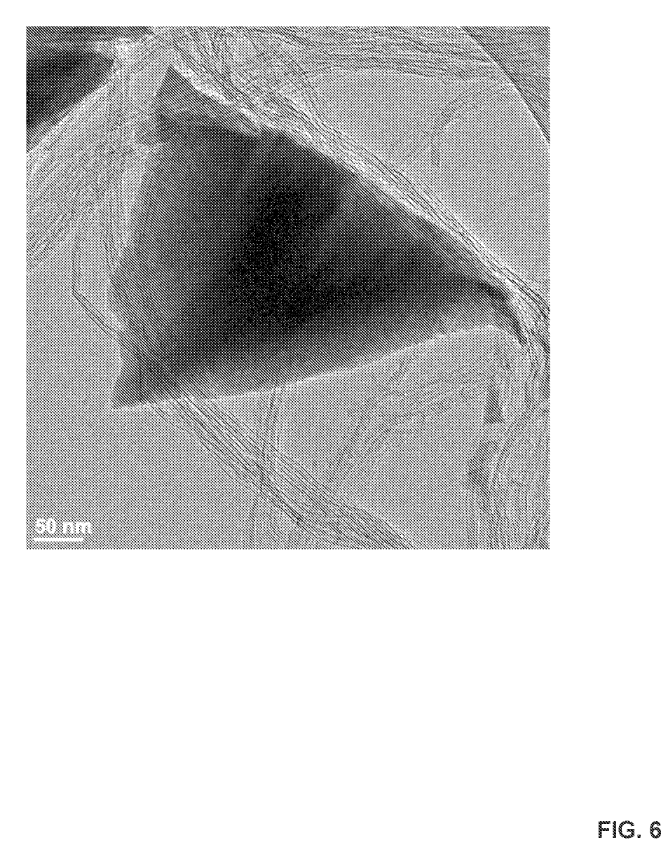

The triangle of Ge/GCNT in FIG. 5D, boxed by red, was selected for further analysis. A high magnification TEM image in FIG. 6 shows that Ge is deposited on few-walled CNTs. The corresponding scanning TEM (STEM) image of Ge/GCNTs and the elemental mapping images of Ge and C are shown in FIGS. 5G, 5H and 5I, respectively. From the elemental mapping, it is confirmed that the Ge is distributed on the GCNT matrix.

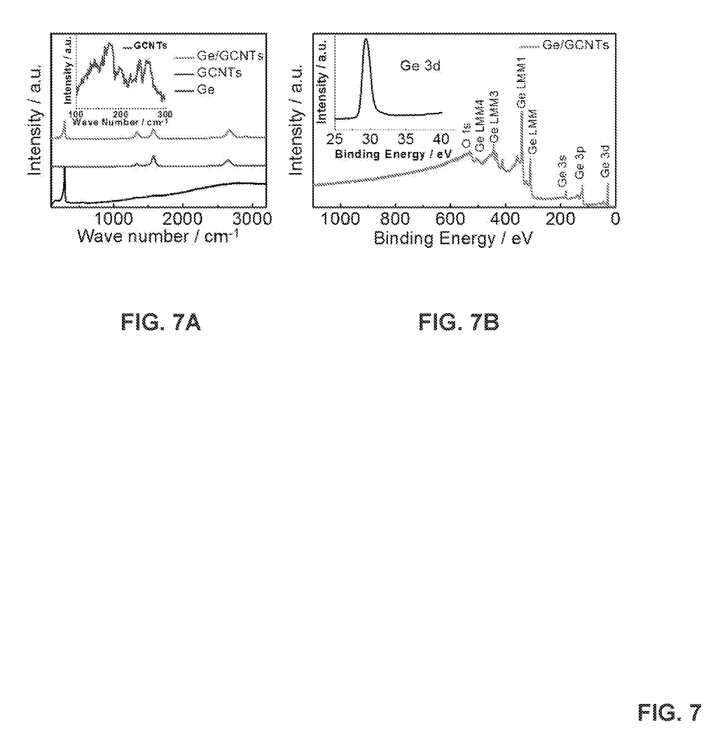

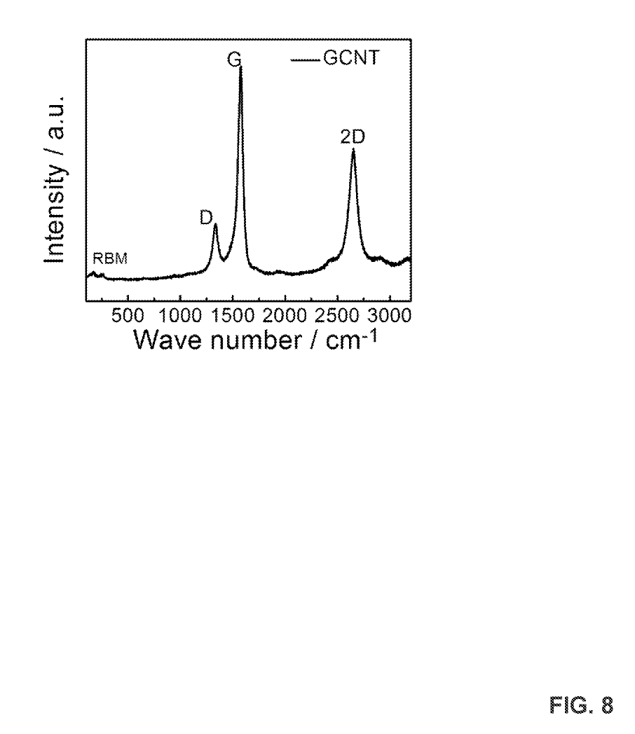

Compositional analysis of Ge/GCNTs was performed using Raman spectroscopy, and X-ray photoelectron spectroscopy (XPS), as shown in FIG. 7. FIG. 7A provide the Raman spectra of Ge film, GCNTs and Ge/GCNTs, respectively. Strong CNT peaks are observed from the GCNTs with a G/D ratio of ˜5:1, indicating high quality CNTs with low defects (the enlarged Raman spectrum of GCNT is in FIG. 8).

It has been reported that the CNT forest grown by the aforementioned Odako mechanism mainly consists of single-walled carbon nanotubes (SWCNTs) with a few 2-3 walled nanotubes. The strong RBM signal in FIG. 7A establishes the presence of SWCNTs, which is in agreement with the previous results. A Raman spectrum of Ge/GCNT is in the inset of FIG. 7A. In addition to the characteristic peak from the CNT forest, a strong signal is at 295.4 cm⁻² that corresponds to the Ge. This indicates the successful loading of Ge on the GCNT framework. XPS analysis was also conducted to determine the composition of the Ge/GCNT. The survey spectrum shows the Ge distinguishing peaks. A small O 1s peak was detected due to slight oxidation of the sample during transfer. After surface Ar etching, the fine scan of Ge 3d centered at 29.4 eV indicates the formation of metallic Ge on the GCNT structure.

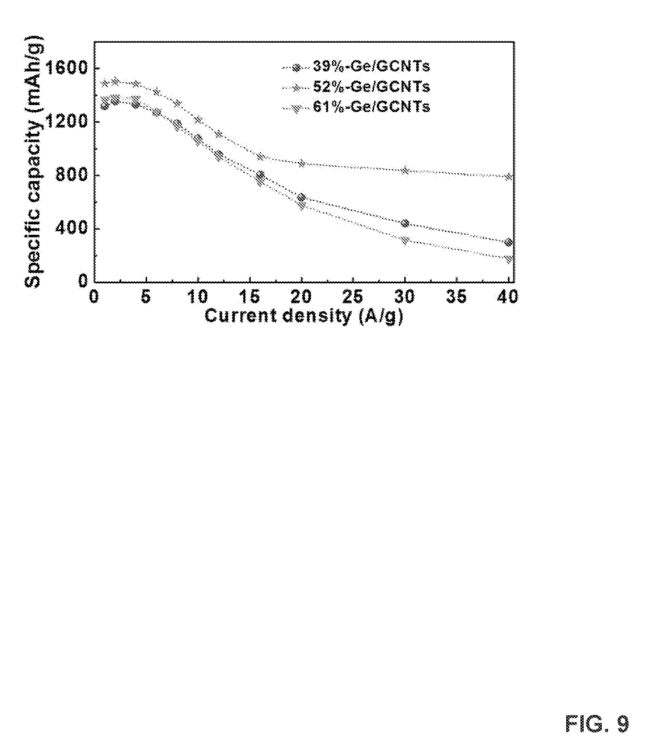

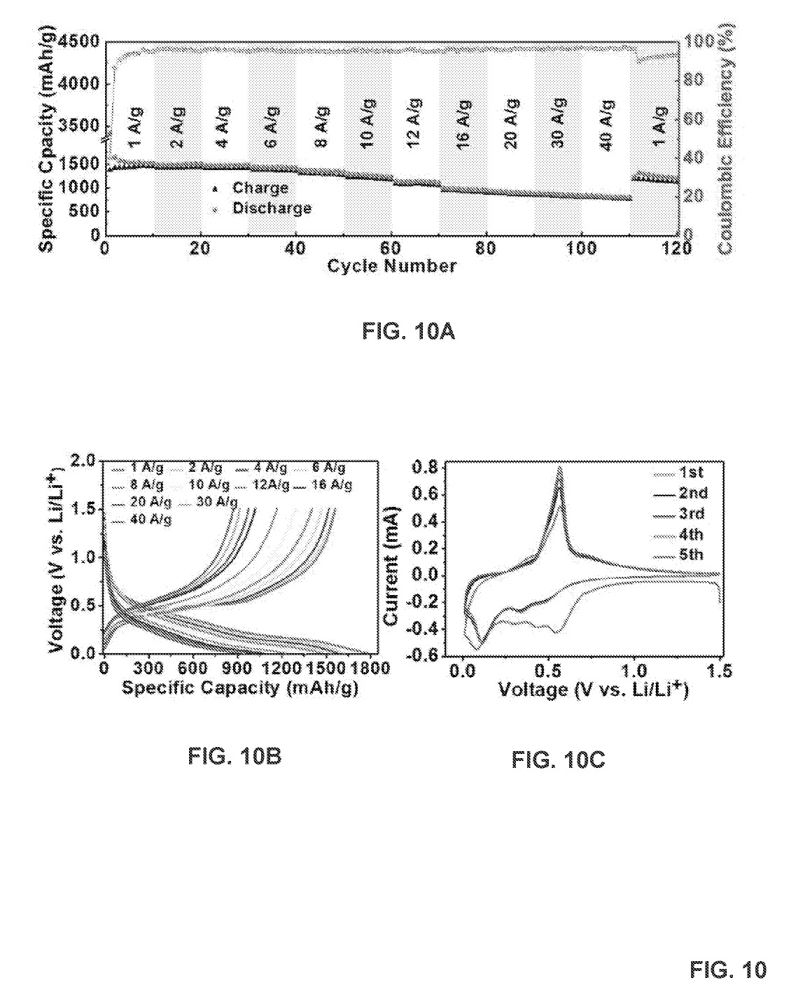

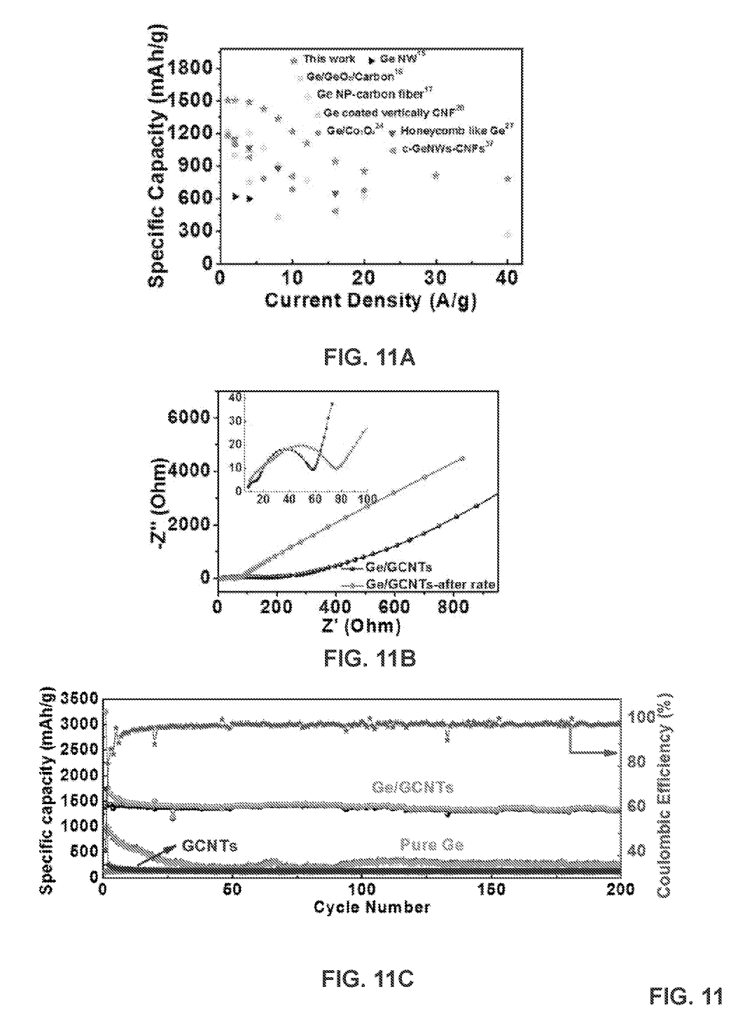

The electrochemical lithium storage properties of Ge/GCNTs as an anode material in LIBs were investigated by cyclic voltammetry (CV) and galvanostatic discharge/charge cycles in a CR2032 coin cell using Li metal as the counter electrode between 0.01 and 1.5 V. The thickness of the Ge was varied from 150, 250 and 350 nm (the thickness is monitored by the e-beam evaporator during the deposition). The corresponding mass percentages of Ge were fixed at 39%, 52% and 61% to the total mass of GCNTs and Ge, respectively. The influence of Ge mass loading on the battery performance showed that Ge/GCNTs with mass loading of 52% have the highest specific capacities at the same current density (FIG. 9). The detailed electrochemical properties of Ge/GCNTs (52%-Ge/GCNTs) are summarized in FIGS. 10-11.

One of the major advantages of Ge compared to other group IV elements is its higher Li ion diffusivity, which contributes to its high rate performance. FIG. 10A shows the rate capability of Ge/GCNTs. The reversible specific capacity is 1524 mAh/g at the 10th cycle at 1 A/g, which is close to the theoretical capacity of Ge (1600 mAh/g). This value for the specific capacity of Ge/GCNTs was derived by subtracting the contribution of GCNTs from the corresponding rate.

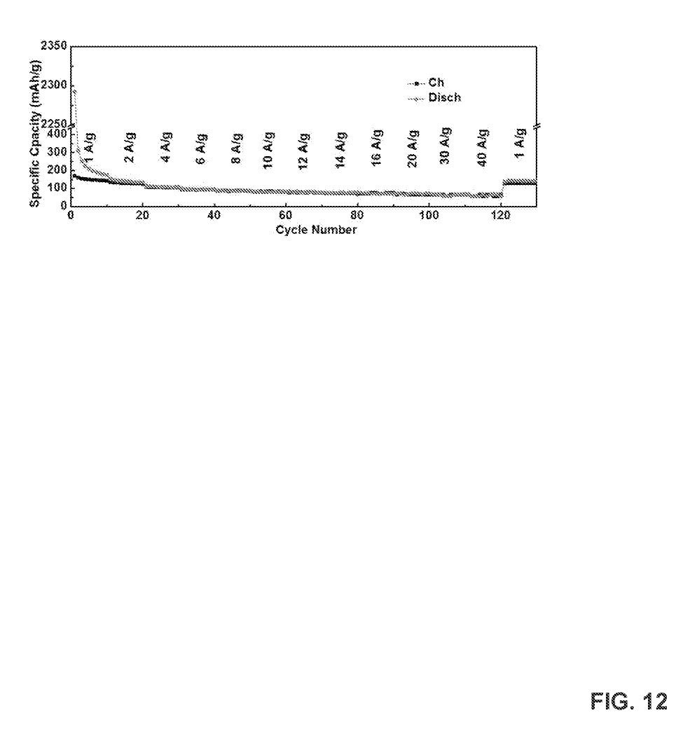

The rate performance of the pure GCNTs is shown in FIG. 12. When the current densities were increased to 2, 4, 6, 8, 10, 12, 16, 20, 30 and 40 A/g, the reversible specific capacities of Ge/GCNTs were 1508 (20th), 1486 (30th), 1427 (40th), 1336 (50th), 1237 (60th), 1111 (70th), 948 (80th), 887 (90th), 813 (100th) and 803 (110th) mAh/g, respectively. When the current density was reduced to 1 A/g (111st), the electrode still delivered a very high specific capacity of 1245 mAh/g with 0.18% capacity decay in each cycle, implying the optimal rate capacity and structural stability.

FIG. 10B shows the discharge/charge voltage profiles at the corresponding current densities. With the increased current densities, the profiles remained uniform with flat voltage plateaus. The discharge curves show three discharge plateaus under 0.5 V, the main discharge plateau is ˜0.2 V, and there is only one charge plateau (˜0.5 V) that is a typical characteristic of Ge electrodes.

The detailed reactions during the lithiation/delithiation process can be analyzed from the CV curves in FIG. 10C. In the first discharge cycle, there are four distinct cathodic peaks. The broad peak at 0.55 V results from the formation of the solid electrolyte interface (SEI) that disappeared during the subsequent cycles, indicating the formation of SEI at the first cycle. The peaks at 0.44, 0.30 and 0.01 V are ascribed to the formation of LiₓGe alloys. In the first anodic scan, the peak at 0.56 V represents the reversible reaction, which shifts a little after the first cycle. The CV curves show extensive overlap, indicating good reversibility of the electrochemical reactions.

According to the results, the Ge/GCNTs anode shows the best rate performance when compared to published work on other Ge anodes. The comparison is shown in FIG. 11A. The rate performance is mainly attributed to the good connections of graphene with both copper and CNTs. Evidence for these good connections is shown in the EIS spectra (the black curve in FIG. 11B), implying that the Ge/GCNTs have very low contact resistance and charge transfer resistance. Even after the harsh rate performance testing, the resistance of Ge/GCNTs has only a slight increase, indicating the high stability of the structure and optimal electrical conductivity of the material, even under the extremely high current operation.

FIG. 11C shows the cycling performances of Ge/GCNTs, GCNTs electrode and pure Ge film at 0.5 A/g, respectively. The reversible discharge and charge specific capacities for Ge/GCNT are 1764 mAh/g and 1463 mAh/g at the second cycle, corresponding to a Coulombic efficiency of 83%. The large capacity loss of the first several cycles is mainly attributed to the formation of SEI and irreversible Li insertion into the GCNT. This conclusion is supported by the cycling curve for GCNTs with a great capacity loss at the initial cycles.

The GCNT electrode delivered a stable specific capacity of 150 mAh/g, which indicates that the capacity contribution from the GCNTs is small. The Coulombic efficiency of Ge/GCNTs is larger than 96% after the initial cycles and remained stable, indicating optimal electrochemical stability of the Ge/GCNT anode. After 200 cycles, the specific capacity of Ge/GCNTs was maintained at 1315 mAh/g, indicating high capacity retention of 91%. Compared with pure Ge film that had a large reversible capacity of 1038 mAh/g and decayed to 263 mAh/g after 30 cycles, Ge/GCNTs delivered both high capacity and high stability.

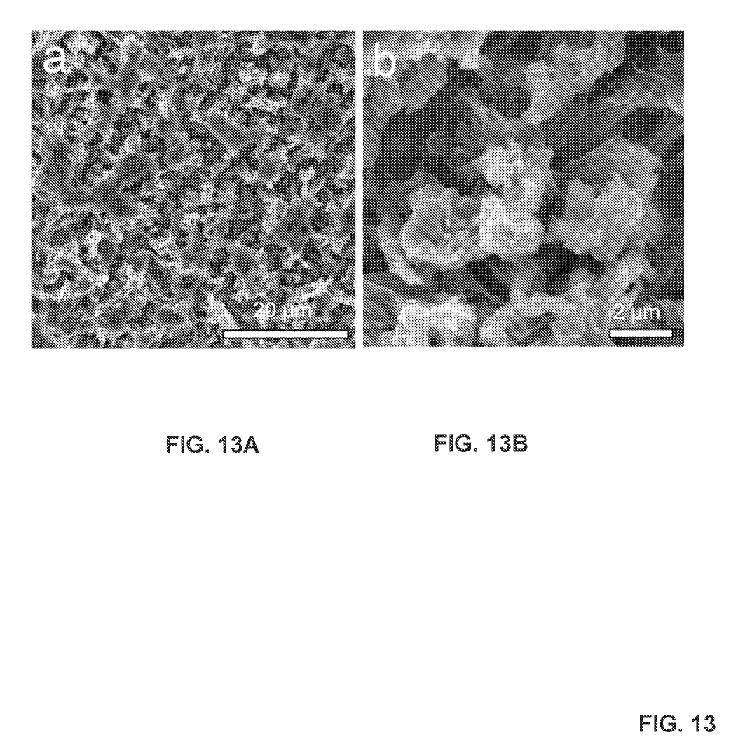

To obtain further evidence of the structural stability of Ge/GCNTs, the morphology of Ge/GCNT electrode after 200 cycles at a rate of 0.5 A/g was investigated by SEM, as shown in FIG. 13. The Ge/GCNT electrode remained a continuous and interconnected structure without any apparent fractures. Therefore, the integration of GCNTs into the electrode enhanced the electroactivity and cycling stability of Ge/GCNTs.

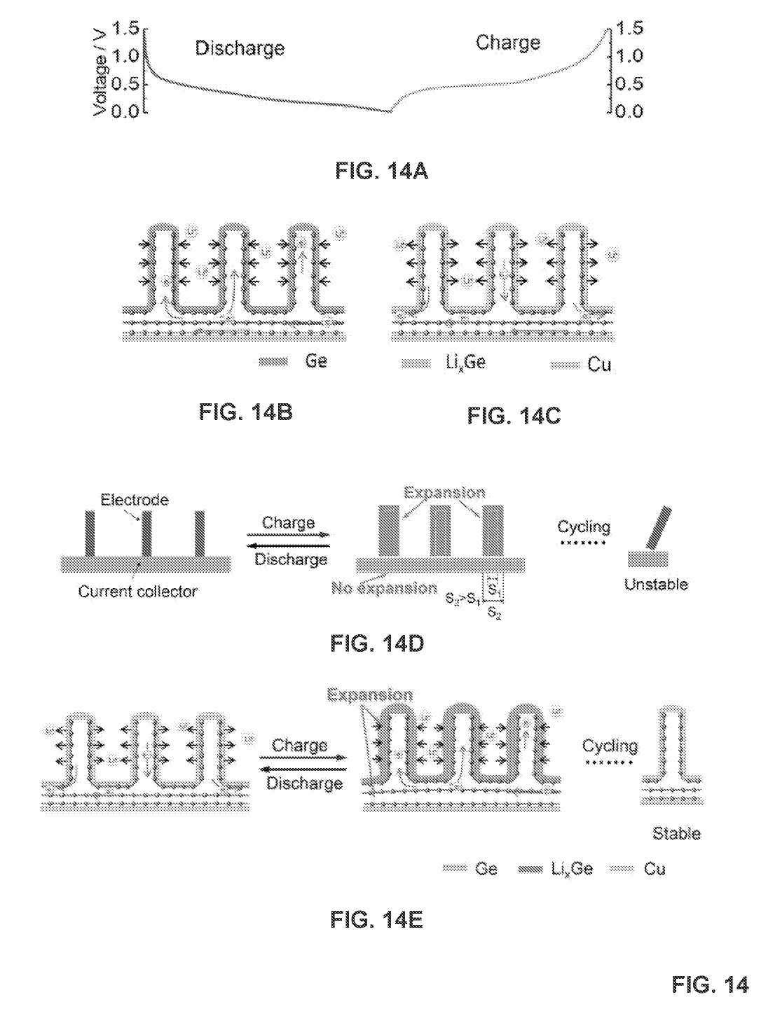

When the hierarchical electrode material was directly grown on CC, the expansion only occurred in the electrode material in the charge process. This means that S2 is larger than S1 (S1 is the pristine diameter of the electrode material and S2 is the diameter of the electrode material after expansion). The electrode material may also lose contact with the CC during cycling due to the inactive lithium properties of the CC in most cases (FIG. 14D).

On the other hand, in Ge/GCNT electrodes, the volume can change simultaneously during the charge/discharge processes (FIG. 14E). Meanwhile, graphene has an intimate contact with the CC (e.g., Cu foil), which can alleviate the strain between the interfaces. In addition, GCNTs provide not only fast electron transport because of the seamless and covalently connected interface between graphene and CNTs, but also fast lithium-ion transport attributed to the short lithium diffusion distance between the active material and the high coverage of electrolyte to the active material. Therefore, as illustrated in FIGS. 14A-E, the Ge/GCNT anode can deliver high electrochemical performances in a stable manner.

In summary, GCNT was used as a binder and additive-free current electrode for Ge anode in LIBs. The GCNT electrode provides high SSA for Ge and a high speed transport network for electron/lithium ion. Meanwhile, graphene is an effective carbon layer in GCNTs due to its good mechanical properties and the good contact with both the CC and CNTs. The developed Ge/GCNT anode delivers optimal cycling stability and rate capability. The specific capacity was maintained at 1333 mAh/g after 200 cycles, indicating high capacity retention of 91%. Moreover, the Ge/GCNT anode has a high specific capacity of 803 mAh/g at an extremely high current density of 40 A/g. Therefore, the integrate GCNT structure provides a new strategy to promote the electrochemical performance in LIBs by enhancing the connections between current collector and electrode.

### Example 1.1. Preparation of GCNT Structures

Few-layer graphene was grown on the electrochemically polished Cu foil using chemical vapor deposition (CVD). The Cu foil was inserted into and removed from the furnace using a magnet assisted boat-shaped quartz holder. The substrate was first annealed at 1,000° C. for 10 minutes under H₂ flow (300 sccm) and the pressure was controlled with a needle valve to 350 Torr. Then the carbon source gas, CH₄ (10 sccm), was introduced into the quartz tube. After 15 minutes, the CH₄ gas was turned off and the copper substrate was removed from the furnace area and cooled to room temperature under H₂ flow.

For the growth of the GCNT hybrid structure, 1 nm Fe and 1 nm Al₂O₃ catalyst were deposited on top of the few-layer graphene by e-beam evaporation. The thickness of the catalyst was selected such that the GCNT was to have a bundled structure with a wide opening at the top, rather than a vertically aligned carpet morphology. The wide opening allowed the e-beam evaporated Ge to be deposited deeper in the GCNT and make good contact with the CNTs. The CNT forest was then grown using a water-assisted hot filament furnace.

### Example 1.2. Fabrication of Ge/GCNT Electrodes

Amorphous Ge was deposited on Cu with or without GCNT structure using an electron beam evaporator. The evaporation was conducted under a high vacuum of 3×10⁻⁶ Torr with a deposition rate of 0.2 nm/s for the first 50 nm. The deposition rate was increased to 1 nm/s up to the desired thickness of Ge. The loading mass of Ge was determined by the weight difference before and after Ge coating using a microbalance (Cahn C31 microbalance; sensitivity is 0.1 μg). The average mass density was 0.26 mg/cm² at 250 nm.

### Example 1.3. Assembly and Testing of Lithium-Ion Batteries

Electrochemical tests were performed using CR2032 coin-type cells with a lithium metal foil as the counter electrode. The electrolyte was 1 M LiPF₆ in a solution of ethylene carbonate and diethyl carbonate (1:1 vol:vol). Celgard 2500 membrane was used as a separator. CV tests were performed on a CHI660D electrochemical station at a current density of 0.40 mV/s. EIS measurements were carried out on the CHI660D at an open circuit potential in the frequency range of 100 kHz to 10 mHz. The galvanostatic discharge-charge test was carried out on a LAND CT2001A battery system at room temperature.

### Example 1.4. Materials Characterization

The electrode materials were characterized by SEM (JEOL 6500 field); TEM and scanning TEM (STEM) (200 kV JEOL FE2100); Raman microscope (Renishaw Raman RE01 scope); and XPS (PHI Quantera). Ar etching with an accelerating voltage of 3 kV for 60 seconds was applied to etch the surface several nm deep for the fine XPS scan.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

1-69. (canceled)

70. An electrode comprising:
a conductive substrate;
at least one graphene layer in conformal contact with the conductive substrate;
vertically aligned carbon nanotubes extending from and in ohmic contact with the at least one graphene layer; and
a uniform germanium layer applied directly to the vertically aligned carbon nanotubes.

71. The electrode of claim 70, wherein the at least one graphene layer consists essentially of few-layer graphene.

72. The electrode of claim 70, wherein the vertically aligned carbon nanotubes consist essentially of single-walled carbon nanotubes.

73. The electrode of claim 70, wherein the vertically aligned carbon nanotubes include multi-walled carbon nanotubes.

74. The electrode of claim 70, wherein the uniform germanium layer extends between the vertically aligned carbon nanotubes.

75. The electrode of claim 70, wherein the uniform germanium layer extends between bundles or arrays of the vertically aligned carbon nanotubes.

76. The electrode of claim 70, wherein the at least one graphene layer provides a highly conductive electron transfer pathway between the vertically aligned carbon nanotubes and the conductive substrate.

77. The electrode of claim 70, wherein the uniform germanium layer includes germanium particles.

78. The electrode of claim 77, wherein the carbon nanotubes extend through the germanium particles.

79. The electrode of claim 78, wherein individual ones of the carbon nanotubes extend through individual ones of the germanium particles.

80. The electrode of claim 77, wherein the germanium particles consist essentially of amorphous germanium.

81. The electrode of claim 70, wherein the uniform germanium layer constitutes 25 wt % to 75 wt % of a combined mass of the vertically aligned carbon nanotubes and the uniform germanium layer.

82. The electrode of claim 81, wherein the uniform germanium layer constitutes about 52 wt % of the combined mass of the vertically aligned carbon nanotubes and the uniform germanium layer.

83. The electrode of claim 70, wherein the uniform germanium layer has a germanium-layer thickness of between about 150 nanometers and 350 nanometers.

84. The electrode of claim 83, wherein the germanium-layer thickness is about 250 nanometers.

85. The electrode of claim 70, wherein the vertically aligned carbon nanotubes are grouped in nanotube bundles.

86. The electrode of claim 85, wherein the nanotube bundles have inter-tube spacings in a range of from three angstroms to twenty angstroms.

87. The electrode of claim 85, further comprising channels separating the nanotube bundles.

88. The electrode of claim 87, wherein the channels range from five angstroms to twenty angstroms in width.

89. The electrode of claim 70, further comprising a van der Waals interface between the conductive substrate and the at least one graphene layer.

90. The electrode of claim 70, further comprising a covalent interface between the at least one graphene layer and the vertically aligned carbon nanotubes.
